(19) United States
(12) Patent Application Publication
(10) Pub. No.: US 2022/0258770 A1
(43) Pub. Date: Aug. 18, 2022

(54) Method for Supporting a Vehicle Driver of a Vehicle in Driving of the Vehicle, and Electronic Driver Support System and Vehicle

(71) Applicant: Volkswagen Aktiengesellschaft, Wolfsburg (DE)

(72) Inventors: Matthias Klawitter, Braunschweig (DE); Ramona Behrendt, Braunschweig (DE)

(73) Assignee: Volkswagen Aktiengesellschaft, Wolfsburg (DE)

(21) Appl. No.: 17/670,624

(22) Filed: Feb. 14, 2022

(30) Foreign Application Priority Data
Feb. 16, 2021 (DE) 10 2021 201 459.3

(51) Int. Cl. B60W 60/00; B60W 40/09; G01C 21/34

(52) U.S. Cl. CPC B60W 60/0051; B60W 2540/229; G01C 21/3461; B60W 40/09

(57) ABSTRACT

A method for supporting a vehicle drive of a vehicle in driving of the vehicle during travel is disclosed, comprising the following steps:
providing inattentiveness information from multiple vehicle drivers of vehicles, wherein the inattentiveness information characterizes at least one type of inattentiveness with regard to traffic observation of a vehicle driver on at least one route section of a roadway,
determining a current position of the vehicle by during travel, providing the position of the at least one route section and/or detecting the position of the route section,
supporting the vehicle driver of the vehicle in driving of the vehicle by supporting the attentiveness of the vehicle driver in the zone around the route section if the current position of the vehicle is identified as being in said zone around the route section.

### CROSS-REFERENCE TO RELATED APPLICATIONS

This application claims priority to German Patent Application No. DE 10 2021 201 459.3, filed on Feb. 16, 2021 with the German Patent and Trademark Office. The contents of the aforesaid Patent Application are incorporated herein for all purposes.

### TECHNICAL FIELD

The invention relates to a method for supporting a vehicle driver of a vehicle in driving of the vehicle during travel by locomotion of the vehicle. Furthermore, the invention relates to an electronic driver support system and to a vehicle comprising a corresponding electric driver support system.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

In order for a driver or respectively vehicle driver or respectively vehicle operator of a vehicle to be able to perform safe travel by locomotion in road traffic, it may be important that the driver is in a suitable state for being able to perform safe travel by locomotion. It may be identified based on the driver's state whether a driver is currently capable of performing the relevant driving tasks for travel by locomotion in a motor vehicle. In other words, it may be important that the driver is capable of performing the required driving tasks during travel by locomotion of the vehicle.

The assessment of the driver's state plays an important role in assisted and/or autonomous driving of a vehicle. In the case of autonomously driving vehicles or highly automated vehicles, the relevant driver's state may be important for being able to set the driver assistance systems or assistance systems.

For example, there are indirect measuring methods for determining a driver's state. For the reasons given above, reliable methods or processes for detecting the driver's state are required in order to ensure high quality and reliability of the assessment of the driver's state and to reliably check the plausibility of other methods.

A disadvantage of known systems is that a driver's state may only be determined for the respective vehicle driver at a particular point in time.

### SUMMARY

A need exists for being able to assess a state of a vehicle driver in a more needs-based and/or a predictive manner for a driving situation.

The need is addressed by a method, an electronic driver support system, and a vehicle according to the independent claims.

Embodiments of the invention are described in the dependent claims, the following description, and the drawings.

### BRIEF DESCRIPTION OF THE DRAWINGS

FIG. 1 is a schematic representation of an embodiment of a vehicle comprising an electronic driver support system; and

FIG. 2 is a schematic representation of the embodiment of FIG. 1 when driving on a route section.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Some embodiments provide a method for supporting a vehicle driver of a vehicle in driving of the vehicle during travel by locomotion of the vehicle, comprising:
providing inattentiveness information from multiple vehicle drivers of vehicles, wherein the inattentiveness information characterizes at least one type of inattentiveness with regard to traffic observation on the part of a vehicle driver on at least one route section of a roadway during driving of a vehicle,
determining a current position of the vehicle by means of a positioning circuit during travel by locomotion,
providing the position of the at least one route section and/or detecting the position of the route section by means of a detector,
supporting the vehicle driver of the vehicle in driving of the vehicle by supporting the attentiveness of the vehicle driver in a zone around the route section if the current position of the vehicle is identified as being in said zone around the route section.

The proposed method makes it possible to assess a driver's state that characterizes the relevant route section in a route-dependent manner. Based on this driver's state assessed in a route-dependent manner, the vehicle driver of the vehicle may be supported individually by means of a supportive measure that is adapted to the relevant situation and to the route section. As a result, the driver of the vehicle may perform travel by locomotion of the vehicle, for example in the route section, more safely. This increases the safety or respectively driving safety of the vehicle and thus also the safety for road traffic in the route section. Therefore, a driver's state that could present itself in future on a future local route section to be traveled on is also assessed in a predictive manner. Said driver's state does not have to arise at a current point in time in the vehicle driver. However, it may also already begin or have occurred. The method is, for example, a computer-implemented method.

For example, the driver of the vehicle is supported during travel on the route section such that ideally, no dangerous traffic situations may arise. As a result, dangerous situations such as accidents or rear-end collisions or other traffic hazards are reduced or prevented.

The inattentiveness information may in some embodiments be provided as swarm data of a vehicle fleet or from fleet data from multiple vehicles to the relevant vehicle (ego vehicle). Vice versa, the vehicle (ego vehicle) may in some embodiments transmit and provide its own data relating to the driving behavior of the driver in the relevant route section to other vehicles, for example fleet vehicles. As a result, comprehensive and diverse collections of data and data analyses relating to the attentiveness in the route section may be saved and processed for the relevant route section. As such, comprehensive data may in some embodiments be provided to the vehicles of a vehicle fleet for any desired route section. As a result, the dangers arising from this specific route section may be minimized. Consequently, the individual vehicles may be informed or respectively made aware or respectively trained in some embodiments based on the transmitted inattentiveness information in such a way that the particular driving behavior of the vehicle driver and, for example, the driving behavior of the vehicle itself are adapted to accident-free and safe driving behavior or target driving behavior in the route section.

For example, but without limitation, the vehicle may be a truck or bus or passenger car. The vehicle may in some embodiments be an electric vehicle or a vehicle with an internal combustion engine. For example, the vehicle may be a fully autonomous or semi-autonomous or highly automated vehicle.

The driver of the vehicle is, for example, the vehicle operator or respectively vehicle driver.

The type of attentiveness may, for example, be tiredness of the vehicle driver or distractedness of the vehicle driver from the traffic situation or safety-critical driving behavior or inappropriate behavior of the vehicle driver. Distractedness from the traffic situation may, for example, be the gaze of the vehicle driver being directed at a landmark in the surroundings or another event in the surroundings and/or in the vehicle that distracts the attention of the vehicle driver. Equally, this may be a corresponding object in the surroundings that draws the attention of the vehicle driver. For example, this relates to events or objects in the zone around the route section. For example, the inattentiveness is characterized or respectively defined by a deviation from optimal or respectively safe traffic observation of the vehicle driver on the route section. Consequently, the inattentiveness information for example reflects a deviation from the norm or respectively from a target behavior during travel on the route section.

The route section may, for example, be a stretch or portion of a roadway that is traveled on during locomotion of the vehicle. For example, the route section may be a curve or chicane or section of a highway or mountain road or tunnel. If applicable, the relevant inattentiveness information may be adapted for the relevant types of route section in some embodiments. For example, the inattentiveness information may be stored in an external data cloud or respectively server or back end in some embodiments. For example, the inattentiveness information is stored in a digital fleet server or digital central processing unit. The vehicles of the vehicle fleet may then retrieve the relevant information for the relevant route section at any time via communication links in some embodiments. Equally, the individual vehicles of the vehicle fleet may transmit the current inattentiveness information relating to themselves to the central processing unit. As such, a continuously updated database may be provided for the inattentiveness information.

For example, the current position of the vehicle may be determined by means of a GPS system or based on the navigation system of the vehicle. The position of the at least one route section may also be provided by means of GPS (global positioning system) or GNSS or by means of the navigation system. Equally, the relevant position of the route section may be determined by the vehicle itself. For this purpose, the vehicle may comprise corresponding detectors (also referred herein as ‘detection units’) or respectively sensor(s) by means of which the route section lying ahead or respectively the surroundings of the vehicle may be detected. The position of the route section may be determined from the recorded information, for example by means of an electronic evaluation circuit (also referred herein as ‘evaluation unit’) of a driver assistance system of the vehicle. The term ‘circuit’ herein may comprise arrangements of hardware, software, or combinations thereof.

If it is identified based on the evaluation of an electronic computing circuit or electronic evaluation circuit or electronic processor that the current position of the vehicle is in a zone around the route section, i.e. in an area immediately around the route section, supportive measures may then be provided to the vehicle driver depending on the inattentiveness information relating to this route section. In other words, when it is identified that the vehicle will very soon be or is currently traveling on the route section, the vehicle driver is supported depending on the inattentiveness information such that the attentiveness of the vehicle driver is adapted to the current situation for traveling on the route section. For example, the attentiveness of the vehicle driver is increased by means of said support of attentiveness. As such, the vehicle driver may drive the vehicle more safely when traveling on the route section, such that no accidents or dangerous situations, for example, may occur.

In some embodiments, by means of a monitoring circuit of the vehicle, the vehicle driver is continuously monitored during driving of the vehicle and a current state of attentiveness of the vehicle driver is determined depending on said monitoring, wherein the current state of attentiveness of the vehicle driver is taken into consideration during support of the attentiveness of the vehicle driver in the zone around the route section. In other words, the vehicle driver's driving of the vehicle and the driving behavior or respectively the state of attentiveness of the vehicle driver may be assessed or respectively ascertained at any point in time. Therefore, the particular state of attentiveness of the vehicle driver may be ascertained accurately and precisely over a defined period of time. As a result, it is possible, for example, to establish whether the driver is not paying attention even before traveling on the route section. In this way, corresponding supportive measures or respectively countermeasures or respectively auxiliary functions may be implemented or respectively activated early on prior to the vehicle entering the zone around the route section. As a result, the basic driving or respectively forward movement of the vehicle on the part of the vehicle driver may be carried out more safely and, for example, in a manner that is safer for traffic. On account of the continuous monitoring or respectively detection or respectively observation of the vehicle driver, a wide variety of types of inattentiveness may be recorded or respectively detected. For example, tiredness of the vehicle driver may be inferred from a steering behavior or eyelid closing reflex to closed eyes. Equally, deviations or respectively diversions of the gaze of the vehicle driver from the direction of actually observed traffic toward the route section lying ahead may also be detected. For example, a gaze of the vehicle driver to the left or right of the vehicle may be identified. As a result, supportive measures may be initiated and offered or respectively provided to the vehicle driver as early as when the inattentiveness or respectively distractedness of the vehicle driver is detected. Furthermore, a gaze onto a phone or respectively mobile telephone or smartphone may be detected as the state of inattentiveness, for example. Equally, a length of time for which the vehicle driver averts their gaze from the roadway may also be detected.

For example, the monitoring circuit may comprise a driver observation camera or interior camera or sensor or camera unit or other detector of the vehicle. For example, the monitoring circuit may also be part of an electronic driver support system. In this connection, the respectively detected state of attentiveness of the vehicle driver may be transmitted (wirelessly or by wire) and thus provided via communication links to the electronic driver support system. As a result, targeted and timely supportive measures or respectively support may be offered and provided to the vehicle driver.

In some embodiments, at least one type of support is determined depending on the state of attentiveness of the vehicle driver and the inattentiveness information, wherein the at least one type of support is taken into consideration during support of the attentiveness of the vehicle driver in the zone around the route section. For example, the state of attentiveness of the vehicle driver and the inattentiveness information may be stored in a central data memory or respectively in an electronic or respectively digital data memory. Said data memory may be part of a fleet server of a vehicle fleet. As a result, the state of attentiveness of the vehicle driver and the inattentiveness information may be stored in the data memory in correlation with one another. As such, said information may be taken into consideration by other road users when traveling on the route section.

In other words, the electronic driver support system and, for example, an electronic evaluation circuit of the electronic driver support system may evaluate or respectively link or respectively correlate or respectively analyze the state of attentiveness and the inattentiveness information. This information may be used to ascertain a precise state of inattentiveness or respectively a current level of tiredness or respectively state of distraction of the vehicle driver for the route section, for example in real time. Therefore, specific support may be provided in a manner adapted to the situation at any time and at any position within the zone in the route section. As such, optimal and efficient support of the vehicle driver may be achieved during travel on the route section.

For example, the type of support may be an indicative or respectively instruction-based output of information to the vehicle driver, or another type of possible support may be system-side intervention in at least one vehicle concept or a driver assistance system of the vehicle.

In some embodiments, the vehicle driver is supported by means of acoustic and/or optical and/or haptic warning messages and/or behavior information and/or supportive hints in the zone around the route section as at least one type of support. Alternatively or additionally and in some embodiments, the vehicle driver may be supported in the zone around the route section in that, as at least one type of support, at least one control signal is generated and provided for at least one driver assistance system depending on the state of attentiveness of the vehicle driver and the inattentiveness information. For example, a driving behavior of the vehicle in the zone around the route section is automatically adapted by means of the driver assistance system depending on the at least one control signal. In other words, the vehicle driver may be informed via corresponding hints and/or instructions and/or information and/or techniques, such that the vehicle driver may perform corresponding support themselves by readapting the current driving behavior themselves. For example, the vehicle driver may be warned by means of an output unit of the vehicle or an output unit of the electronic driver support system such that the vehicle driver is made aware of the fact that they are currently in a state of inattentiveness. In this regard, the vehicle driver may be informed that they are currently tired or distracted or stressed or in poor health. For example, by means of the acoustic and/or optical and/or haptic warning messages and/or behavior information and/or supportive measures, the vehicle driver may be brought closer to an improved driving behavior that is adapted to the route section. Thus, for example, a current speed limit or steering wheel setting or a willingness to brake or a cruise control setting or a manual setting of other vehicle systems may be indicated to the vehicle driver. Equally, the vehicle driver may be suggested special driving strategies or respectively an alternative route through the route section. Consequently, the vehicle driver may adapt the driving behavior themselves and independently such that the vehicle may be maneuvered safely through the route section.

Another type of support is that of adjusting or respectively adapting driver assistance systems. Depending on the inattentiveness information and/or the state of attentiveness, one or more control signals may be produced or respectively generated, by means of which a wide variety of driving systems and/or vehicle components and/or driver assistance systems may be adjusted or respectively adapted in some embodiments. Optionally, driver assistance systems may be preconditioned for imminently driving on the route section by means of the state of attentiveness and the inattentiveness information. For example, an ACC (adaptive cruise control) system may be preconditioned such that a distance from the vehicle driving ahead or from a vehicle following on behind the vehicle is adjusted or respectively increased. For example, a speed limit for driving on the route section may be set by means of cruise control. As such, a driver assistance system can, for example, be adjusted such that the maximum speed for driving on the route section is set at a maximum value. As a result, no unintended speed increase may occur, such that the route section may be driven on more safely.

Another possibility for a type of support is that of physical stimuli being output to the vehicle driver in some embodiments. For example, this may take place by means of actuators and/or a special system in the passenger compartment and/or on or in the driver's seat. In this connection, when increased inattentiveness is detected, for example tiredness or even microsleep, the vehicle driver may be made more alert or awakened by means of the output of physical stimuli. As a result, the attentiveness of the vehicle driver may be increased.

For example, the driver assistance system may automatically and independently intervene in the driving or respectively intervene in the current driving behavior of the vehicle with the aid of the inattentiveness information and/or state of attentiveness and/or a distance between the current position of the vehicle and the position of the route section. As such, corresponding measures may be introduced and implemented for example even before the route section is driven on.

In some embodiments, averaged inattentiveness information that is generated by averaging multiple states of attentiveness of multiple vehicle drivers of other vehicles is provided as the inattentiveness information for at least one type of inattentiveness. In order to be able to obtain detailed informative value for the inattentiveness information relating to the route section, it is beneficial if a wide variety of highly comprehensive information from a wide variety of vehicles, for example the vehicle drivers of the respective vehicles, is averaged or respectively analyzed or respectively evaluated over a specific period of time and/or over a specific amount of information. As such, an average inattentiveness or respectively average state of inattentiveness of the vehicle drivers in the route section may be determined, for example. For example, the accuracy of any occurring inattentiveness may be provided precisely in this route section by means of a large measurement quantity. Therefore, the vehicle driver may be offered and provided with better and more efficient support when driving on the route section. The calculation of the average or respectively averaged inattentiveness information may take place in the central processing unit/processor or respectively in an electronic evaluation circuit and be provided to multiple vehicles, for example to the vehicles of a vehicle fleet. As such, all vehicles may obtain the most up-to-date information that has been brought up to the current standard relating to driving on the relevant route section.

For example, based on the averaged inattentiveness information, a probability of related inattentiveness occurring on the route section may be determined. Accordingly, it may be determined on the system side whether inattentiveness may occur on an upcoming route section of the vehicle. As such, it may be estimated or respectively assessed in advance whether support is even required or respectively required in principle. In this way, unintended support that would disturb the vehicle driver more may be prevented. The probability may be determined by means of a large amount of highly comprehensive inattentiveness information relating to the multiple vehicle drivers of other vehicles.

For example, the type of support and/or the time of the support and/or the duration of the support may be determined or specified using the determined probability of the inattentiveness occurring. As such, support that is adapted precisely to the relevant route section and to the current situation may be provided to the vehicle driver. Therefore, the best possible support that is adapted to a driver may take place. For example, a probability of a particular type of inattentiveness occurring may be generated for a wide variety of types of inattentiveness in each case.

For example, it may be ascertained how probable it is on this route section that a vehicle driver is tired or distracted by looking to the left or right out of the vehicle window of the vehicle or by looking at a display or mobile phone. Therefore, an individual and adapted supportive measure may be provided and implemented for a wide variety of situations that may be responsible for the inattentiveness of the vehicle driver. As a result, it is possible to react accordingly to specified situations when the vehicle driver is driving on the route section.

In some embodiments, multiple different types of inattentiveness of a vehicle driver on the at least one route section of the roadway are provided or respectively determined by means of the inattentiveness information, and individual support in driving of the vehicle is assigned to each of the multiple types and, for example, carried out if necessary. In other words, a basic supportive measure or respectively a suitable and/or predefined supportive measure may be classed beforehand in a database or respectively fleet server and/or central processing unit for a wide variety of forms or respectively types of inattentiveness. In other words, the wide variety of types of inattentiveness may be classified or respectively categorized. As such, the various types of inattentiveness may be divided into different categories or respectively classes, such that a decision as to which supportive measures are currently best suited to the vehicle driver in order to increase their attentiveness may be made more quickly in principle. The suitable (individual) support may be selected from a categorization or classification database by means of the electronic driver support system depending on the determined type of inattentiveness of the vehicle driver and output to the vehicle driver, for example immediately. As a result, the vehicle driver may be offered individual and faster support as needed when driving the vehicle in a route section.

In some embodiments, it is checked whether the current position of the vehicle is in the zone around the route section by means of a digital (electronic) map in which the position of the at least one route section and the inattentiveness information associated with this route section are stored. In other words, a wide variety of route sections may be stored in an electronic, digital map. In turn, for each of these route sections, a wide variety of inattentiveness information and/or specific circumstances and/or specific driving situations and/or the type of inattentiveness and/or the averaged inattentiveness units relating to this route section may be stored as subcategories. Consequently, basic information relating to possible support may be retrieved and prepared for when said information is needed as early as when it is checked whether the vehicle is currently in the zone around the route section. As a result, corresponding measures for increasing the attentiveness of the vehicle driver may be provided early on in a very fast and very simple manner. For example, the digital map may be stored in a global data cloud or respectively global backend or global server unit. A wide variety of vehicles may have access to these digital maps and retrieve the relevant inattentiveness information relating to a desired route section. Equally, vehicles of a vehicle fleet, for example, may update the relevant data relating to a route section in the digital map or store new data relating to a new route section. As a result, an up-to-date and current digital map may be generated and provided or respectively kept ready for the vehicles.

For example, the digital maps may be used as swarm data of the vehicle fleet. For example, the digital map may use the camera-based map and locating technology “Road Experience Management” (REM). As such, fleet data may, for example, be used to continuously improve navigation maps with highly precise locating capabilities.

In some embodiments, at least one instance of supporting the attentiveness of the vehicle driver during driving of the vehicle in the zone around the route section is stored as an item of additional information for the at least one route section in the digital map, for example the item of additional information is provided to other vehicles in the zone around the route section. In other words, after support or respectively a supportive measure has been carried out during driving of the vehicle by the vehicle driver in the route section, this situation may be evaluated and analyzed. As such, an item of event information or respectively an empirical value relating to the support in the route section may be provided. This may either be provided directly to a fleet server or to another vehicle or be stored in the digital, electronic map as additional information or respectively an item of additional information relating to the relevant route section. For future supportive measures, other vehicles in the route section may be provided with an even better and more efficient supportive measure for the respective vehicle driver. On account of the large amount of additional information, such as that relating to the support provided, a continuous learning process may take place with regard to support in a route section. For example, said learning process may be performed by the electronic driver support system such that said system may be constantly updated and improved. As such, in future, even better support may be provided in the relevant route section, since the respective empirical values from previous instances of support may be learned.

Some embodiments relate to an electronic driver support system comprising at least a positioning circuit, a detector and an electronic evaluation circuit, wherein the electronic driver support system is designed to carry out or respectively perform the method according to the teachings herein. For example, the above-described method is carried out using the electronic driver support system that has just been presented.

For example, the electronic driver support system may be integrated as a driver assistance system in the vehicle. For example, the driver support system may be connected or digitally connected to a wide variety of other driver assistance systems in the vehicle. For example, the electronic driver assistance system is in constant communicative exchange with a central server (unit) (for example the fleet server) in order to be able to pick off the relevant information and data for the current instance of support of the vehicle driver of the vehicle and to be able to determine the support therefrom. Equally, corresponding data may be provided to other vehicles and/or servers by means of the electronic driver support system.

Some embodiments relate to a vehicle comprising an electronic driver support system according to the teachings herein. For example, the vehicle is a motor vehicle or bus or truck or passenger car or electric vehicle or hybrid vehicle. For example, the vehicle may be designed as a vehicle that is operated in a fully autonomous manner or that is operated in a semi-autonomous manner or that is highly automated. For example, the vehicle may contain multiple driver assistance systems. For example, the vehicle contains the electronic driver support system for supporting a vehicle driver of a vehicle in driving of the vehicle during travel by locomotion of the vehicle.

In the exemplary embodiments described herein, the described components of the embodiments each represent individual features that are to be considered independent of one another, in the combination as shown or described, and in combinations other than shown or described. In addition, the described embodiments can also be supplemented by features other than those described.

Embodiments of the electronic driver support system and of the vehicle that comprise features of the like described in conjunction with the embodiments of the method also belong to the invention. For this reason, the corresponding embodiments of the electronic driver support system and of the vehicle will not be described again.

The invention also includes combinations of the features of the embodiments described.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS.

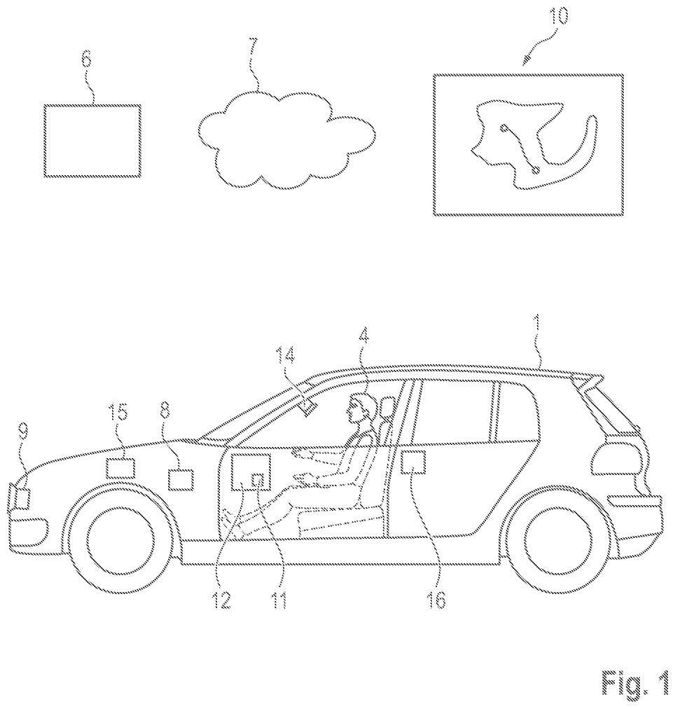

FIG. 1 is a schematic representation of a vehicle 1. The vehicle 1 may, for example, be a motor vehicle or automobile or truck or bus or electric vehicle. If applicable, the vehicle 1 may be a fully autonomous or semi-autonomous highly automated vehicle.

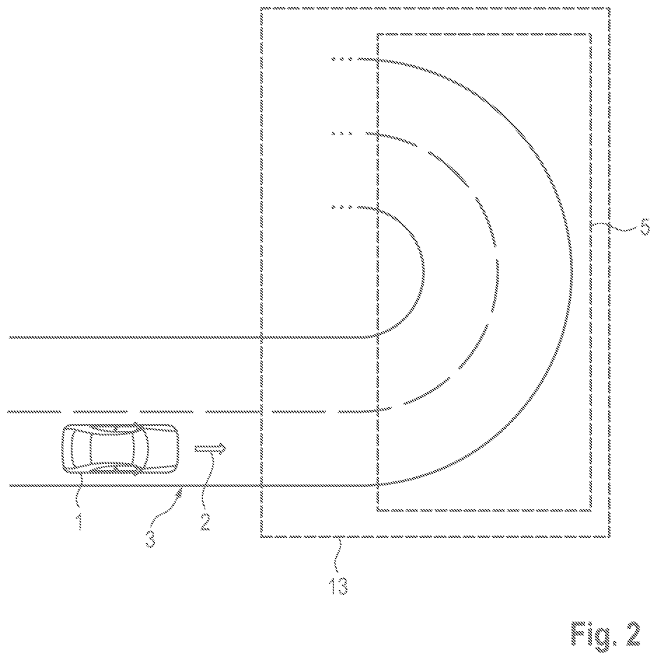

For example, the vehicle 1 is located along a roadway 3 of a highway during travel by locomotion 2 (cf. FIG. 2). For example, the travel by locomotion 2 may be predefined in a predefined direction of travel of the vehicle 1. For example, the vehicle 1 may be traveling by locomotion or respectively traveling by motion or respectively be on a journey along a highway or country road or a road with traffic calming or other places.

For example, the travel by locomotion 2 of the vehicle 1 is carried out by a vehicle driver 4 or vehicle operator or respectively driver or respectively by a person. For example, the vehicle driver 4 drives the vehicle 1 during the travel by locomotion 2 of the vehicle 1 along the roadway 3.

In order to be able to control or respectively drive the vehicle 1 safely, it is imperative that during the travel by locomotion 2 the vehicle driver 4 is in a state or respectively is behaving such a way as to be ready to drive, alert, safe to traffic and capable of acting. The vehicle driver 4 may only perform safe travel by locomotion 2 with the vehicle 1 safely and in a manner safe to traffic and, for example, in a manner safe to other road users if they may attentively observe events on the road or respectively in the traffic. As such, it may be very important that the vehicle driver is highly attentive or respectively has a high level of attentiveness. As a result, the vehicle driver 4 may react quickly and safely to unforeseeable traffic situations along the roadway 3.

However, certain situations and/or human incidents or route-dependent positions or personal conditions may cause the vehicle driver 4 to become inattentive or respectively less attentive during the travel by locomotion 2. This may be the case, for example, if the vehicle driver 4 is distracted by objects in or outside the vehicle 1 or by looking to the left or right out of the vehicle 1. For example, the vehicle driver 4 may be distracted by looking at a portable communication terminal (mobile phone or tablet). For example, a critical driver's state is one in which the vehicle driver 4 is tired or respectively is in a state of tiredness. In this case, the ability of the vehicle driver 4 to act and react and, for example, their attentiveness is significantly reduced or respectively minimized. As such, it may be very important to assess a state of attentiveness of the vehicle driver 4, for example in the case of highly automated or semi-autonomous or fully autonomous vehicles. In this connection, it is beneficial if the vehicle driver 4 is supported in driving the vehicle 1 in the event of inattentiveness of the vehicle driver 4 or in the event of imminent (predicted) inattentiveness. As a result, in the event of possible or respectively confirmed inattentiveness of the vehicle driver 4, safe travel by locomotion 2 of the vehicle 1 may still be achieved.

There may be specific road sections or respectively route sections along the roadway 3 in which potential inattentiveness may be more pronounced. Equally, increased attentiveness may be required in said route sections in order to be able to travel on said route section in a manner that is safe to traffic and without posing any danger. In order to be able to provide these hazardous road sections or respectively route sections to the vehicle drivers or respectively vehicles, inattentiveness information from multiple vehicle drivers of vehicles may be provided to other road users. As such, when the multiple vehicles are traveling on a route section 5 (cf. FIG. 2), the respective experiences or respectively empirical values during travel on said route section 5 may be provided as empirical values to other road users. This may be important, for example, in the case of a route section with a steep downhill or uphill slope or a sharp corner or a tunnel.

For example, the inattentiveness information may be saved and stored in a database 6 or data cloud 7. The database 6 or respectively data cloud 7 may be central processing units or a backend or a fleet server of a vehicle fleet. As such, the relevant inattentiveness information from vehicles of a vehicle fleet may be provided to the other vehicles of the vehicle fleet. For example, the vehicles of the vehicle fleet or even other vehicles are communicatively connected to the database 6 or respectively data cloud 7.

At least one type of inattentiveness with regard to the traffic observation on the part of a vehicle driver may be characterized on at least the one route section 5 of the roadway 3 during driving of the vehicle by means of the inattentiveness information. As a result, based on the experiences of the multiple vehicles when traveling on this route section 5 and, for example, travel in the event of occurring driving behavior or respectively driving interventions or respectively instances of inattentiveness may be stored and provided for other road users.

In order to be able to support the vehicle driver 4 in accordance with any possible inattentiveness, it may be firstly important to compare the position of the vehicle 1 with the position of the route section 5. For this purpose, the current position of the vehicle 1 may be determined by means of a positioning circuit 8. The positioning circuit 8 may, for example, be a global positioning system (GPS) receiver or a global navigation satellite system (GNSS) receiver. Equally, the current position of the vehicle may be ascertained by means of the navigation system of the vehicle 1. The positioning circuit 8 may, for example, also be used to determine the position of the route section 5. Otherwise, the position of the route section 5 (i.e., the route section 5 lying ahead) may be detected or respectively ascertained or respectively determined by means of a detector 9 of the vehicle 1 based on the current position of the vehicle 1. The detector 9 may, for example, be a camera-based system or a sensor-based system that is arranged in the front region of the vehicle 1, for example. Equally, it is also conceivable for the position of the route section 5 to be transmitted to the vehicle 1 via communicative or respectively communication links. In this case, the positions of the route section may also be stored in the database 9 or respectively data cloud 7. Furthermore, the position of the route section 5 may be stored in a digital (electronic) map 10. The digital map 10 is, for example, a navigation map or respectively traffic map or respectively road map. Not only may conventional navigation data be stored in the digital map 10, so too may the relevant specific route section 5.

In order to be able to support the vehicle driver 4 when necessary, an electronic evaluation circuit 11 (electronic computing unit/computer or respectively electronic processing unit/processor or respectively electronic data unit/processor) of an electronic driver support system 12 compares or respectively contrasts the current position of the vehicle 1 with the position of the route section 5. The above-mentioned electronic driver support system 12 may be integrated in the vehicle 1 as a driver assistance system or as part of an existing driver assistance system. For example, the electronic driver support system 12 is not only communicatively, digitally and electronically linked or respectively connected to the electronic on-board power supply of the vehicle 1, but it is also connected to the database 6, data cloud 7 and the digital map 10. Equally, the electronic driver support system 12 is communicatively connected to the positioning circuit 8 and detector 9. As a result, a wide variety of data and information may be requested and provided between them.

For example, it is checked by means of the electronic evaluation circuit 11 as to whether the current position of the vehicle 1 coincides with a zone 13 (cf. FIG. 2) around the route section 5.

For example, the zone 13 is a predefined or respectively predeterminable or respectively predetermined surrounding region or respectively radius or respectively sector or surrounding region around or respectively along the route section 5. This makes it possible for the inattentiveness relating to said route section 5 to be evaluated before the route section 5 is traveled on and for corresponding support to then be presented to the vehicle driver 4 at said point. By providing a larger zone 13 than the original route section 5, a check and thus corresponding supportive measures may be implemented early on. As such, the vehicle driver 4 may be prepared or respectively made aware of imminent hazardous traffic situations or instances of inattentiveness as best as possible at an early stage.

If it was identified that the position of the vehicle is in the zone 13 or respectively there is a match, the vehicle driver 4 may be supported in driving of the vehicle 1 by means of support of the attentiveness of the vehicle driver 4 in the zone 13 around the route section 5. As such, the vehicle driver 4 may be supported not only along the route section 5, but also within the zone 13. As a result, the route section 5, for example, and the zone 13 or respectively region around the route section 5, for example, may be traveled on by the vehicle 1 in a more efficient manner and in a manner that is safe to traffic.

In order to be able to better compare the position of the vehicle 1 and the position of the route section 5, not only may the position of the route section 5 be provided in the digital map as information, so too may information relating to the inattentiveness (inattentiveness information) or the type of inattentiveness or another specific route-dependent item of information (for example relating to tiredness or distractedness) or a hazard level or a hazard potential of the route section 5. As such, the electronic driver support system 12, for example, may call up specific information in the digital map 10. As a result, the electronic driver support system 12 not only obtains the position of the route section 5, but also the related or respectively associated or respectively characterizing data or respectively information (for example with regard to inattentiveness). Consequently, a wide variety of information may be called up in parallel as early as during the check of the position of the vehicle 1 and of the zone 13. As such, the vehicle driver 4 may be assisted faster.

Another beneficial application or respectively a beneficial use case of the digital map 10 is that of being able to provide an instance of the attentiveness of the vehicle driver 12 actually being supported during driving of the vehicle 1 in the zone 13 as additional information to other road users by means of the electronic driver support system 12. For example, empirical values relating to the route section 5 traveled on in the digital map 10 may be stored or respectively added to the route section as a subcategory. As such, said additional information may be provided to other vehicles (for example vehicles of a vehicle fleet) as information for a future instance of the route section 5 being traveled on. As a result, future vehicles may be provided with even more efficient and even better support for safely traveling on the route section 5.

For example, the data or respectively information stored in the digital map 10 may be used and provided as swarm data (MKE, ADA) or as “Road Experience Management” (REM) data. In this case, the digital map 10 is applied, for example, as camera-based map and locating technology. As such, a wide variety of data of the vehicles, for example from fleet vehicles, may be stored and retrieved in said digital map in a constant and up-to-date manner. On account of the wide variety of information of the wide variety of vehicles, a constantly updated digital map may be provided for road users. In order to be able to offer and provide the best possible support for the vehicle driver 4, the information relating to the current state of attentiveness of the vehicle driver 4 is, of course, also of importance in the stored data or respectively information. For this purpose, the vehicle driver 4 may be continuously monitored or observed during driving of the vehicle 1 by means of a monitoring circuit 14 (camera or sensor or driver observation camera or interior camera) of the vehicle 1.

For example, the monitoring circuit 14 may be part of a driver assistance system 15 of the vehicle or part of the electronic driver support system 12. A current state of attentiveness of the vehicle driver 4 may be determined or respectively ascertained based on the monitoring or detection performed. For example, the state of attentiveness is a current level of distractedness or a current level of tiredness or a current stress level of the vehicle driver 4. For example, the monitoring circuit 14 monitors whether the vehicle driver 4 is distracted from observing the traffic (for example they are looking out of the side window or at the backseat) or whether, for example, the vehicle driver 4 is looking at a smart device or infotainment system or navigation system.

Based on the state of attentiveness, it is possible for the electronic evaluation circuit to establish the extent to which the vehicle driver 4 is able to act and react when traveling on the route section 5. For example, the state of attentiveness of the vehicle driver 4 may be categorized or respectively classified. The support for driving of the vehicle 1 may take place to a greater or lesser extent depending on how low or respectively high the level of attentiveness of the vehicle driver 4 is. For example, at least one type of support may be determined depending on the state of attentiveness of the vehicle driver 4 and the inattentiveness information and other information. This may, for example, be done by means of the electronic driver support system 12. The relevant type of support is taken into account or respectively applied, for example, when the attentiveness of the vehicle driver 4 is supported in the zone 13 around the route section 5. As such, respective corresponding support that is adapted to the situation may be offered and provided to the vehicle driver 4.

For example, a voice of the driver (vehicle driver 4) may be recorded or respectively taped by means of corresponding sensors in order to determine the current state of attentiveness or respectively state of tiredness or respectively driver's state 4. In order to be able to assess the attentiveness of the vehicle driver 4, the electronic driver support system 12 may ask the driver questions (the system prompts the driver to speak) at regular or irregular time intervals. Based on the respective responses, the system may then evaluate the speech or respectively spoken language of the driver with regard to tiredness, distractedness, stress, health or ability to act by means of corresponding sensors (microphones). This may take place using special software or algorithms. In this connection, the electronic driver support system 12 may be adapted or respectively trained or respectively machine-trained based on the relevant personal speech behavior of the driver. The tiredness recognition system 12 may be used for multiple people if the above-mentioned systems is connected to other vehicles (fleet vehicles, fleet servers, backends, digital maps). The system is, for example, digitally connected to the server backend (database 6 or respectively data cloud 7) or data may also be transmitted accordingly between vehicles by means of smartphones of the driver. For example, the driver may be prompted to speak at regular intervals, for example without being intrusive, in order to increase the attentiveness of the driver. Existing voice-control systems of the vehicle 1 may be used for this purpose.

By evaluating the speech, different types of behavior or respectively patterns of behavior that cannot be detected in a completely reliable manner by existing sensors may be analyzed or respectively assessed based on the evaluated speech or respectively evaluated speech behavior. For example, the relevant spoken language of the driver may be evaluated by means of corresponding evaluation systems (algorithms or artificial intelligence) throughout the journey time of the vehicle 1. As a result, for example, the behavior or respectively driving behavior of the driver (for example the attentiveness) may be modified and, for example, adapted in a person-specific manner. The tiredness, distractedness, stress or health of the driver, for example, may be evaluated and analyzed by means of the tiredness recognition system 12. System-side warnings may be output to the driver depending on the relevant driver's state. Furthermore, the above-described speech evaluation may be used to check the plausibility of other driver support systems. In order to be able to better evaluate the relevant driving behavior or respectively the relevant state of attentiveness of the driver, data relating to the driver's state may be evaluated on the system side by means of an AI algorithm (artificial intelligence) or similar methods. For example, the state of the driver in terms of attentiveness, driving style, tiredness and ability to act may be ascertained based on the recorded data by means of the monitoring circuit 14 or from data of the database 6. This result may be displayed to the driver (vehicle operator 4) in the form of an animated character or animated avatar via a display unit (infotainment system) of the vehicle 1. Based on this avatar or respectively character or respectively animation, the vehicle driver 4 can, for example, be shown a recognized state of inattentiveness in a very simple manner. As such, the relevant driver's state may be output to the driver themselves in an understandable manner. For example, when it has been established that the driver is not being attentive, corresponding recommendations for action (as support) may be output to the driver by means of said animations. As such, the driver learns of what they must do in order to be able to alter or respectively improve their current state in a verifiable manner by means of a playful form of representation. This may be displayed to the driver by means of the avatar or respectively character in the form of movements, facial expressions, acoustic cues, speech, posture, emotional state. For example, the driver may accordingly set or predefine the relevant character or respectively avatar via corresponding systems or respectively driver profiles or applications. As such, the driver may set the character suited to them.

In order to be able to support or respectively help the vehicle driver 4 by means of support or respectively a supportive measure that is adapted to the relevant situation, the vehicle driver 4 may be supported by means of acoustic and/or optical and/or haptic warning messages and/or behavior information and/or supportive hints in the zone 13 as at least one type of support. As such, the vehicle driver 4 may adapt or respectively improve their driving behavior or respectively state of attentiveness themselves based on this output information. For example, this may take place via an output circuit 16 in the vehicle. Equally, it is also conceivable to increase the attentiveness of the vehicle driver by means of physical stimuli. This is beneficial, for example, in the event of microsleep or a high level of tiredness. If the vehicle 1 is an autonomous (fully autonomous or semi-autonomous) or highly automated vehicle comprising one or more driver assistance systems 15, at least one control signal may be generated for the at least one driver assistance system 15 as another type of support depending on the relevant state of attentiveness of the vehicle driver 4. For example, active and automatic intervention in the driving behavior of the vehicle 1 may be performed by means of the control signal of the driver assistance system 15, which may, for example, be an ACC system or emergency brake system or steering system of the vehicle 1. As such, in the case of the vehicle driver 4 being highly inattentive, the system intervenes at least in part in the driving behavior. As such, hazardous traffic situations, for example, may be prevented in spite of the vehicle driver 4 being inattentive.

For example, the at least one driver assistance system 15 may be adjusted or adapted accordingly depending on the inattentiveness information or respectively state of attentiveness of the vehicle driver 4.

For example, averaged (predicted) inattentiveness information that is generated by averaging multiple states of attentiveness (for example stored in a database 6 or data cloud 7) of multiple different vehicle drivers of other vehicles, for example of a vehicle fleet, may be provided as the inattentiveness information for at least one type of inattentiveness. As such, based on this, a probability of inattentiveness occurring on the route section 5 may be generated or respectively predicted. This may then be taken into account during support of the vehicle driver 4. For example, the type of support and/or the time of the support and/or the duration of the support may be created or respectively generated by means of the electronic evaluation circuit 11 based on this predicted possible probability of inattentiveness occurring.

Furthermore, multiple different types of inattentiveness of the vehicle driver 4 on the at least one route section 5 of the roadway 3 may be provided or respectively determined by means of the inattentiveness information and individual support in driving of the vehicle 1 may be assigned to each of the multiple types. Therefore, the various forms of inattentiveness may be categorized or classified. As such, depending on the actual inattentiveness of the vehicle driver 4, the support or respectively supportive measure that is exactly adapted to said inattentiveness or to this situation may take place.

For example, a route-dependent evaluation of the tiredness of the vehicle driver 4 may be carried out by means of the electronic driving system 12 based on REM data. In this way, for example, enhanced connectivity of the vehicle 1 or respectively a combination of various systems of the vehicle 1 may be utilized better. The use of REM data also improves the possibility of digitalizing vehicles.

### LIST OF REFERENCE NUMERALS

1 Vehicle
2 Travel by locomotion
3 Roadway
4 Vehicle driver
5 Route section
6 Database
7 Data cloud
8 Positioning circuit
9 Detector
10 Digital map
11 Evaluation circuit
12 Electronic driver support system
13 Zone around the route section
14 Monitoring circuit
15 Driver assistance system
16 Output circuit

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for supporting a vehicle driver of a vehicle in driving the vehicle during travel of the vehicle, comprising:
obtaining inattentiveness information from multiple vehicle drivers of vehicles, wherein the inattentiveness information characterizes at least one type of inattentiveness with regard to traffic observation of one or more vehicle drivers on at least one route section of a roadway;
determining a current position of the vehicle during travel using a positioning circuit;
providing the position of the at least one route section and/or detecting the position of the route section using a detector; and
supporting the vehicle driver in driving of the vehicle by supporting the attentiveness of the vehicle driver in a zone around the route section if the current position of the vehicle is identified as being in the zone around the route section.

2. The method of claim 1, comprising, using a monitoring circuit of the vehicle, monitoring the vehicle driver during driving and determining a current state of attentiveness of the vehicle driver depending on the monitoring; wherein the current state of attentiveness of the vehicle driver is taken into consideration during supporting of the attentiveness of the vehicle driver in the zone around the route section.

3. The method of claim 2, comprising determining at least one type of support depending on the state of attentiveness of the vehicle driver and the inattentiveness information, wherein the at least one type of support is taken into consideration during supporting of the attentiveness of the vehicle driver in the zone around the route section.

4. The method of claim 3, wherein the vehicle driver is supported using one or more of an acoustic warning message, an optic message, a haptic warning message, behavior information, and a supportive hint in the zone around the route section as at least one type of support.

5. The method of claim 1, comprising providing averaged inattentiveness information that is generated by averaging multiple states of attentiveness of multiple vehicle drivers of other vehicles as the inattentiveness information for at least one type of inattentiveness.

6. The method of claim 1, comprising providing multiple different types of inattentiveness of a vehicle driver on the at least one route section of the roadway by the inattentiveness information; and assigning individual support in driving of the vehicle to each of the multiple types.

7. The method of claim 1, comprising determining whether the current position of the vehicle is in the zone around the route section using a digital map in which the position of the at least one route section and the inattentiveness information associated with this route section are stored.

8. The method of claim 7, wherein at least one instance of supporting the attentiveness of the vehicle driver during driving of the vehicle in the zone around the route section is stored as an item of additional information for the at least one route section in the digital map.

9. An electronic driver support system comprising a positioning circuit, a detector, a monitoring circuit, and an evaluation circuit, wherein the electronic driver support system is configured for:
obtaining inattentiveness information from multiple vehicle drivers of vehicles, wherein the inattentiveness information characterizes at least one type of inattentiveness with regard to traffic observation of one or more vehicle drivers on at least one route section of a roadway;
determining a current position of the vehicle during travel using the positioning circuit;
providing the position of the at least one route section and/or detecting the position of the route section using the detector; and
supporting the vehicle driver in driving of the vehicle by supporting the attentiveness of the vehicle driver in a zone around the route section if the current position of the vehicle is identified as being in the zone around the route section.

10. A vehicle comprising an electronic driver support system of claim 9.

11. The method of claim 3, wherein the vehicle driver is supported in the zone around the route section by generating, as at least one type of support, at least one control signal; and
providing the control signal to at least one driver assistance system depending on the state of attentiveness of the vehicle driver and the inattentiveness information.

12. The method of claim 11, wherein a driving behavior of the vehicle in the zone around the route section is automatically adapted using the driver assistance system depending on the at least one control signal.

13. The method of claim 2, comprising providing averaged inattentiveness information that is generated by averaging multiple states of attentiveness of multiple vehicle drivers of other vehicles as the inattentiveness information for at least one type of inattentiveness.

14. The method of claim 3, comprising providing averaged inattentiveness information that is generated by averaging multiple states of attentiveness of multiple vehicle drivers of other vehicles as the inattentiveness information for at least one type of inattentiveness.

15. The method of claim 4, comprising providing averaged inattentiveness information that is generated by averaging multiple states of attentiveness of multiple vehicle drivers of other vehicles as the inattentiveness information for at least one type of inattentiveness.

16. The method of claim 2, comprising providing multiple different types of inattentiveness of a vehicle driver on the at least one route section of the roadway by the inattentiveness information; and assigning individual support in driving of the vehicle to each of the multiple types.

17. The method of claim 3, comprising providing multiple different types of inattentiveness of a vehicle driver on the at least one route section of the roadway by the inattentiveness information; and assigning individual support in driving of the vehicle to each of the multiple types.

18. The method of claim 4, comprising providing multiple different types of inattentiveness of a vehicle driver on the at least one route section of the roadway by the inattentiveness information; and assigning individual support in driving of the vehicle to each of the multiple types.

19. The method of claim 5, comprising providing multiple different types of inattentiveness of a vehicle driver on the at least one route section of the roadway by the inattentiveness information; and assigning individual support in driving of the vehicle to each of the multiple types.

20. The method of claim 2, comprising determining whether the current position of the vehicle is in the zone around the route section using a digital map in which the position of the at least one route section and the inattentiveness information associated with this route section are stored.
